(19) United States
(12) Patent Application Publication
(10) Pub. No.: US 2015/0379525 A1
(43) Pub. Date: Dec. 31, 2015

(54) DEVELOPING A CUSTOMER BASE THROUGH SOCIAL NETWORKS AND OTHER SOURCES

(71) Applicant: International Business Machines Corporation, Armonk, NY (US)

(72) Inventors: Rema Ananthanarayanan, New Delhi (IN); Shrinivas Kulkarni, Bangalore (IN); Nisanth M. Simon, Trichur (IN); L. Venkata Subramaniam, Gurgaon (IN)

(21) Appl. No.: 14/314,476

(22) Filed: Jun. 25, 2014

(51) Int. Cl. G06Q 30/02; G06Q 50/00; G06F 17/30

(52) U.S. Cl. CPC G06Q 30/0201; G06F 17/30864; G06Q 50/01

(57) ABSTRACT

Methods and arrangements for identifying a potential customer base of a concern. A contemplated method includes: identifying a prospective customer of a concern, via a social media network; identifying connections of the prospective customer within the social media network; determining a subset of the connections, wherein members of the subset comprise members of the concern; determining connections of the members of the subset; determining whether the connections of the members of the subset comprise the prospective customer; and if the connections of the members of the subset comprise the prospective customer, determining contact information of the prospective customer. Other variants and embodiments are broadly contemplated herein.

### BACKGROUND

Generally, service providers (which can include mobile phone operators or “telecoms”) seek to attract customers who are currently with their competitors, and would especially like to target those that they know are already dissatisfied with their current arrangement. With the increasing use of social media platforms (or social networks), it has become much more common for unhappy customers to post their views, comments and complaints on social media sites, and prospect identification can thus be undertaken through social chatter analysis.

However, a major challenge encountered in reaching out to “prospects” (or prospective/potential customers, by way of developing a potential customer base) involves incomplete contact information, since social media sites frequently only include comments and little else to identify a prospect. Conventionally, there is thus no clearly viable way to determine a prospect's contact information, to reach them or to identify a proper channel that would permit making an offer with a reasonable chance of success.

### BRIEF SUMMARY

In summary, one aspect of the invention provides a method of identifying a potential customer base of a concern, the method comprising: utilizing at least one processor to execute computer code configured to perform the steps of: identifying a prospective customer of the concern, via a social media network; identifying connections of the prospective customer within the social media network; determining a subset of the connections, wherein members of the subset comprise members of the concern; determining connections of the members of the subset; determining whether the connections of the members of the subset comprise the prospective customer; and if the connections of the members of the subset comprise the prospective customer, determining contact information of the prospective customer.

Another aspect of the invention provides an apparatus for identifying a potential customer base of a concern, the apparatus comprising: at least one processor; and a computer readable storage medium having computer readable program code embodied therewith and executable by the at least one processor, the computer readable program code comprising: computer readable program code configured to identify a prospective customer of the concern, via a social media network; computer readable program code configured to identify connections of the prospective customer within the social media network; computer readable program code configured to determine a subset of the connections, wherein members of the subset comprise members of the concern; computer readable program code configured to determine connections of the members of the subset; and computer readable program code configured to: determine whether the connections of the members of the subset comprise the prospective customer; and if the connections of the members of the subset comprise the prospective customer, determine contact information of the prospect.

An additional aspect of the invention provides a computer program product for identifying a potential customer base of a concern, the computer program product comprising: a computer readable storage medium having computer readable program code embodied therewith, the computer readable program code comprising: computer readable program code configured to identify a prospective customer of the concern, via a social media network; computer readable program code configured to identify connections of the prospective customer within the social media network; computer readable program code configured to determine a subset of the connections, wherein members of the subset comprise members of the concern; computer readable program code configured to determine connections of the members of the subset; and computer readable program code configured to: determine whether the connections of the members of the subset comprise the prospective customer; and if the connections of the members of the subset comprise the prospective customer, determine contact information of the prospect.

A further aspect of the invention provides a method comprising: identifying a prospect via a social media network; identifying connections of the prospect within the social media network; determining a subset of the connections, wherein members of the subset comprise members of a concern; determining connections of the members of the subset; determining whether the connections of the members of the subset comprise the prospect; determining whether one or more connections of the members of the subset are members of a competing concern and also comprise the prospect; and thereupon determining contact information of the prospect via: determining a proximity score of a connection of the subset with respect to the prospect, via quantizing, weighting and summing of a plurality of predetermined factors related to proximity; wherein the determining of a proximity score comprises employing at least one of: interaction profile analysis, picture profile analysis, common connections profile analysis, relationship profile analysis, and call data record link analysis.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 schematically illustrates a process of identifying and reaching out to a potential telecom customer.

FIG. 2 schematically illustrates a manner of determining contact details of a potential telecom customer.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

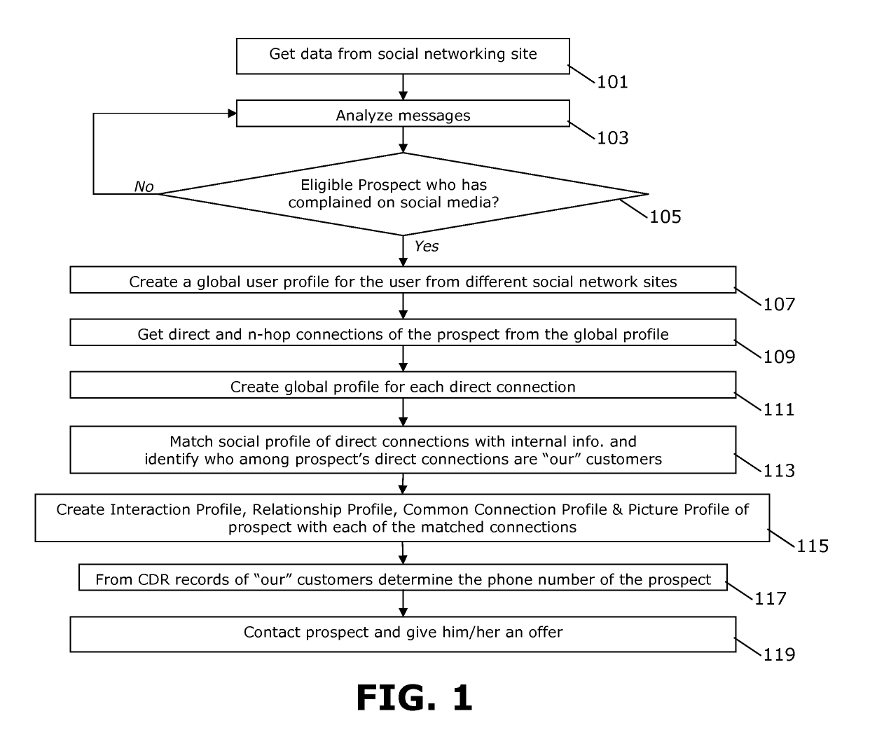

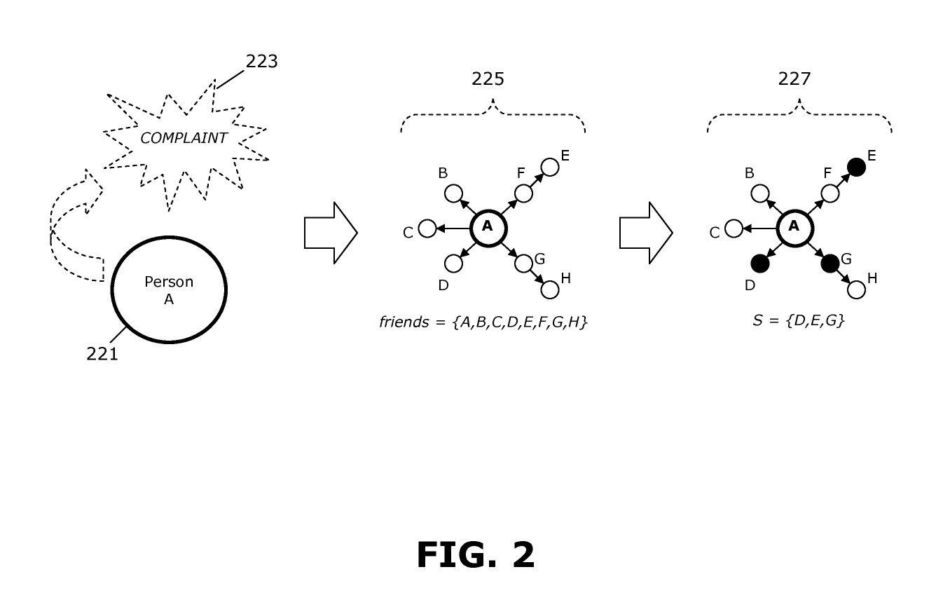

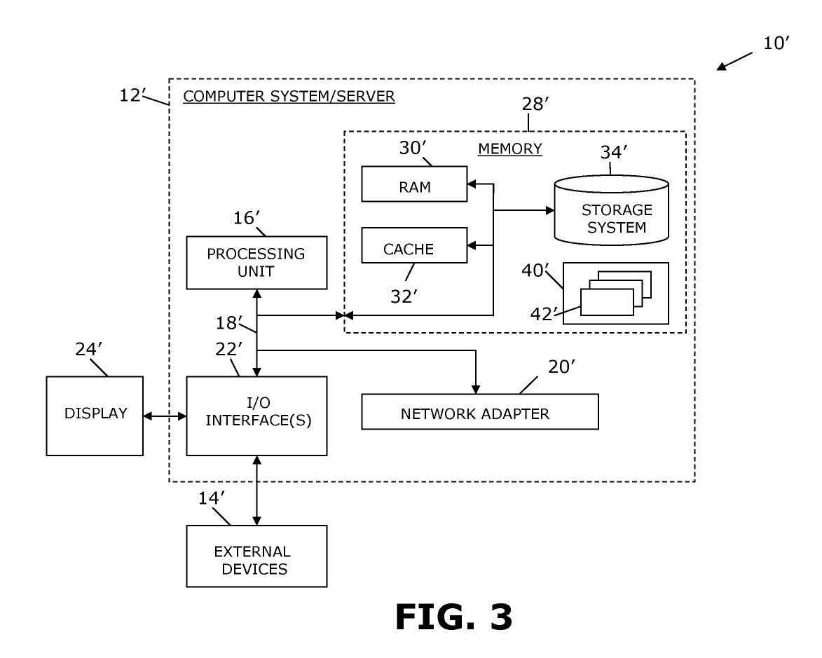

Specific reference will now be made here below to FIGS. 1 and 2. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1 and 2 can be performed or utilized by way of a processing unit or units and system memory such as those indicated, respectively, at 16′ and 28′ in FIG. 3, whether on a server computer, a client computer, a node computer in a distributed network, or any combination thereof.

FIG. 1 schematically illustrates a process of identifying and reaching out to a potential telecom customer (“prospect”), in accordance with at least one embodiment of the invention. Aspects and details of the steps shown in FIG. 1 will be further appreciated, in the ensuing discussion, but are briefly summarized herebelow.

In accordance with at least one embodiment of the invention, data from a social networking site are harvested (101), and viewable messages are analyzed (103). If (105) there is an eligible prospect (in accordance with a definition of “prospect” herein) who has complained about a concern (e.g., about a company such as a telecom) on social media, this prospect is focused upon and a global user profile is created from that and other social network sites (107). From this, direct and n-hop connections of the prospect are determined (109); for each of those connections, a global profile is also created (111). The global profile of these direct connections is then matched with internal information (e.g., call data records or other data) of a given concern (e.g., a telecom T) to determine who among the prospect's connections might be customers of the concern (113). In a manner to be appreciated more fully below, profiles of the prospect can be created (e.g., interaction profile, relationship profile, common connection profile and picture profile) from the aforementioned matched connections (115) and, based on this information and call data records of those connections, the phone number of the prospect can be determined (117). (This phone number can then be stored in memory for later use, and/or can be displayed or transmitted to an individual working on behalf of a given concern, to permit that individual to then contact the prospect.) The prospect can then be contacted with an offer to switch to the given concern (e.g., telecom T) (119).

By way of further elaboration, in accordance with at least one embodiment of the invention, client data available with a service provider (e.g., a telecom T) are used to see if any existing customers have any connections with a prospective customer A (who otherwise is unknown to telecom T, since nothing may be known about him/her outside of his/her viewable social media presence). Analytics can then be applied (i) on the connections of A, as identified from the activities on A's social media site, and (ii) the connections of a subset S (to be explained more fully below), as available from CDRs (call data records), to see if A is connected to any member in S. Here, there can be sought one or more potential connections from set S to candidates who most closely match A.

As shown in FIG. 2, Person A (221) may make a complaint on social media (223), e.g., to the effect that his/her calls (through a given telecom) might get dropped every two minutes. Next, a determination is made of all the 1-hop, 2-hop and n-hop friends and followers (225) of Person A on one or more social media platforms; n can be any predetermined number for reaching a desired search space, while here three hops are shown (n=3). A subset S is then determined (227) that includes members from the set of friends (225) that are already members of telecom T. Subsequent to this, a calling graph is determined for each of the members of S, whereupon it can be determined that some individuals in one or more such calling graphs may be members of one or more given telecoms.

Thus, in accordance with at least one embodiment of the invention, from the calling graphs of S, a determination can be made of all people called who are customers of one or more telecom competitors (CC). Profiles for each member of S (based on CDRs and social media) can be generated as well as for friends of each member of S. Any and all of these profiles can be matched with that of A, to see if there is a potential match. If the match is true, A can be reached out (with the contact information now available) to as a possible new customer of telecom T with a predetermined offer (e.g., via reaching out through one or more members of S).

In accordance with at least one embodiment of the invention, from the viewable social media profile and messages of person A, it is possible to determine his/her home city and roaming locations, to help in narrowing down contact details for A. If GPS (global positioning system) or other location information is available, the exact location of A can be determined for different dates and times. From CDRs, it can then be determined as to when all people in set S speak to others in their network in the locations that A frequents as determined from the social media profile and related messages. Times and locations can be matched with the social media-determined locations for disambiguation purposes.

In accordance with at least one embodiment of the invention, different processes can be employed for constructing and analyzing profiles for reaching person A, especially with respect to people in set S. (As discussed below, this can help determine a proximity score with respect to people in set S, which can provide one or more best paths for reaching A.) These processes include: interaction profile analysis, picture profile analysis, common connections profile analysis, relationship profile analysis and CDR link analysis (i.e., data which can be obtained from determining links or commonalities between CDRs of person A and one or more other individuals).

In accordance with at least one embodiment of the invention, in interaction profile analysis, each interaction in social media between the prospect and a direct connection is analyzed, and information gathered such as: how often they interact, on what topics, the distribution of topics by time, how many times they refer to being together or tag each other, etc. In picture profile analysis, determinations are made relative to photographs such as: the number of pictures in which A and a direct connection are tagged together, the time distribution of pictures together, any subject or tag word associated with common photos (e.g., “birthday” or “family reunion”), and whether there are any common connections who form part of the same picture (as well as their frequency of appearance).

In accordance with at least one embodiment of the invention, in common connections profile analysis, a determination is made as to how many other common connections a prospect shares with a direct connection. In this vein, a determination can be made of topics discussed among common connections, along with a time distribution. This can provide an indication of whether the connections merely exist because they share common interests but don't know each other. Thus, multiple people may follow each other on a common basis such as technology, without knowing each other personally; this can be contrasted with people discussing personal topics on a regular basis. In a relationship profile analysis, an analysis can be made as to whether any data about relationships are mentioned in chatter. Other relationship data can be obtained if already provided in some structured manner (e.g., through a social networking site).

In accordance with at least one embodiment of the invention, analysis factors obtained from processes such as those just discussed (e.g., interaction profile analysis, picture profile analysis, common connections profile analysis, relationship profile analysis and CDR link analysis) can be quantized and individually weighted, and then summed to form a proximity score. This may result in insights such as whether two individuals live in the same household or work at the same workplace, and otherwise can help determine which individuals in set S would represent a more viable route for determining contact information for A or otherwise reaching A through third-party contact (see below). By using such information to determine common times when A and people in set S may be together, and/or via using location information from social media profiles and/or CDRs as discussed heretofore, a determination can be made as to the best times/places to contact A. Thus, in this instance, contact information for a person in set S, and a likelihood that A might also be present, can emerge as an alternative (third-party) manner for contacting A either as an initial measure, or in the event that one or more other measures (e.g., measures which involve contacting A at a known phone number of A directly) might fail.

In accordance with at least one variant embodiment of the present invention, data other than that deriving from CDRs can be used, to the extent that CDRs are discussed herein. For instance, if service companies other than telecoms are being considered, other types of enterprise information may be employed which can then be linked to social media data.

In accordance with at least one variant embodiment of the invention, social media data can be matched with data derived from CRM (customer relationship management) and/or MDM (master data management) to obtain connection details of connections of a prospect.

Referring now to FIG. 3, a schematic of an example of a cloud computing node is shown. Cloud computing node 10′ is only one example of a suitable cloud computing node and is not intended to suggest any limitation as to the scope of use or functionality of embodiments of the invention described herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12′ in cloud computing node 10 is shown in the form of a general-purpose computing device. The components of computer system/server 12′ may include, but are not limited to, at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of identifying a potential customer base of a concern, said method comprising:
utilizing at least one processor to execute computer code configured to perform the steps of:
identifying a prospective customer of the concern, via a social media network;
identifying connections of the prospective customer within the social media network;
determining a subset of the connections, wherein members of the subset comprise members of the concern;
determining connections of the members of the subset;
determining whether the connections of the members of the subset comprise the prospective customer; and
if the connections of the members of the subset comprise the prospective customer, determining contact information of the prospective customer.

2. The method according to claim 1, wherein said determining of connections of the members of the subset comprises determining whether one or more connections of the members of the subset are members of a competing concern.

3. The method according to claim 2, wherein the concern comprises a telecom and the competing concern comprises a competing service provider.

4. The method according to claim 1, wherein said determining of contact information of the prospective customer comprises determining a proximity score of a connection of the subset.

5. The method according to claim 4, wherein said determining of a proximity score comprises employing at least one of: interaction profile analysis, picture profile analysis, common connections profile analysis, relationship profile analysis, and call data record link analysis.

6. The method according to claim 4, wherein said determining of a proximity score comprises quantizing, weighting and summing of a plurality of predetermined factors related to proximity.

7. The method according to claim 1, wherein said determining of connections of the members of the subset comprises consulting call data records of members of the subset.

8. The method according to claim 1, wherein the contact information comprises direct contact information of the prospect.

9. The method according to claim 1, wherein the contact information comprises information for contacting the prospect via a third party.

10. An apparatus for identifying a potential customer base of a concern, said apparatus comprising:
at least one processor; and
a computer readable storage medium having computer readable program code embodied therewith and executable by the at least one processor, the computer readable program code comprising:
computer readable program code configured to identify a prospective customer of the concern, via a social media network;
computer readable program code configured to identify connections of the prospective customer within the social media network;
computer readable program code configured to determine a subset of the connections, wherein members of the subset comprise members of the concern;
computer readable program code configured to determine connections of the members of the subset; and
computer readable program code configured to:
determine whether the connections of the members of the subset comprise the prospective customer; and
if the connections of the members of the subset comprise the prospective customer, determine contact information of the prospect.

11. A computer program product for identifying a potential customer base of a concern, said computer program product comprising:
a computer readable storage medium having computer readable program code embodied therewith, the computer readable program code comprising:
computer readable program code configured to identify a prospective customer of the concern, via a social media network;
computer readable program code configured to identify connections of the prospective customer within the social media network;
computer readable program code configured to determine a subset of the connections, wherein members of the subset comprise members of the concern;
computer readable program code configured to determine connections of the members of the subset; and
computer readable program code configured to:
determine whether the connections of the members of the subset comprise the prospective customer; and
if the connections of the members of the subset comprise the prospective customer, determine contact information of the prospect.

12. The computer program product according to claim 11, wherein said computer readable program code is configured to determine whether one or more connections of the members of the subset are members of a competing concern.

13. The computer program product according to claim 12, wherein the concern comprises a telecom and the competing concern comprises a competing service provider.

14. The computer program product according to claim 11, wherein said computer readable program code is configured to determine contact information of the prospective customer via determining a proximity score of a connection of the subset.

15. The computer program product according to claim 14, wherein determining a proximity score comprises employing at least one of: interaction profile analysis, picture profile analysis, common connections profile analysis, relationship profile analysis, and call data record link analysis.

16. The computer program product according to claim 14, wherein determining a proximity score comprises quantizing, weighting and summing of a plurality of predetermined factors related to proximity.

17. The computer program product according to claim 11, wherein said computer readable program code is configured to determine connections of the members of the subset via consulting call data records of members of the subset.

18. The computer program product according to claim 11, wherein the contact information comprises direct contact information of the prospect.

19. The computer program product according to claim 11, wherein the contact information comprises information for contacting the prospect via a third party.

20. A method comprising:
identifying a prospect via a social media network;
identifying connections of the prospect within the social media network;
determining a subset of the connections, wherein members of the subset comprise members of a concern;
determining connections of the members of the subset;
determining whether the connections of the members of the subset comprise the prospect;
determining whether one or more connections of the members of the subset are members of a competing concern and also comprise the prospect; and
thereupon determining contact information of the prospect via:
determining a proximity score of a connection of the subset with respect to the prospect, via quantizing, weighting and summing of a plurality of predetermined factors related to proximity;
wherein said determining of a proximity score comprises employing at least one of: interaction profile analysis, picture profile analysis, common connections profile analysis, relationship profile analysis, and call data record link analysis.
